(19) United States
(12) Patent Application Publication
(10) Pub. No.: US 2006/0045691 A1
(43) Pub. Date: Mar. 2, 2006

(54) Retractable transportation system

(76) Inventor: Clarence D. Schollmeyer, Killdeer, ND (US)

Correspondence Address: Michael S. Neustel, Suite No. 4, 2534 South University Drive, Fargo, ND, 58103, US

(21) Appl. No.: 10/899,842

(22) Filed: Jul. 26, 2004

(51) Int. Cl. B60P 1/04

(52) U.S. Cl. 414/470

(57) ABSTRACT

A retractable transportation system for transporting loads on a vehicle or trailer with a flatbed design that would otherwise be too wide or too tall to fit on the vehicle or trailer. The retractable transportation system includes a plurality of support members attachable to a trailer bed, a plurality of first arms and second arms pivotally attached to opposing ends of the support members, a first platform attached to the first arms, a second platform attached to the second arms, and a plurality of actuators connected to the support member and the arms for elevating/lowering the platforms.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to transporting large loads (e.g. tractors, equipment) on highways and more specifically it relates to a retractable transportation system for transporting loads on a vehicle or trailer with a flatbed design that would otherwise be too wide or too tall to fit on the vehicle or trailer due to Department of Transportation regulations and vehicle and trailer size constraints.

2. Description of the Related Art

Transportation systems for adapting vehicles and trailers to accommodate oversized loads have been in use for years. Typically, vehicles and trailers have been adapted using different sorts of side members that have been affixed to the side of the vehicle or trailer allowing for a standard vehicle or trailer to haul a load that would not normally fit. These side members have been adapted to become collapsible because of the convenience and lessened requirements imposed (by the Department of Transportation) on vehicles that do not fall under a “wide load” designation. When the side members were collapsible, a trailer could carry a wide load for one portion of a trip and a standard load for another trip, thus escaping the “wide load” designation.

Additional developments were devices which accommodated not only overwidth loads, but high clearance loads as well. This was accomplished through designing the side members to be adjustable not only laterally from the sides, but horizontally from the sides as well. High clearance loads can often be problematic for drivers because of the restrictions on height to travel on certain highways because of the height of concrete overpasses and other similar structures. Any vehicle hauling a load that was too high could contact these overpasses causing catastrophic results. By lowering these side members, loads with physical features such as large farm vehicles could fit their wheels on the dropped side member portions while the normal distance between the bottom of the tires to the bottom of the actual machinery provided enough clearance for the trailer in the middle, standard height portion not to contact any part of the machinery.

Prior vehicle and trailer width and height adaptation systems included pullout sections located underneath a trailer that effectively increased the useful width of the trailer for the portion of the trip necessary to have an increased width. A main problem with these types of adapting systems was if the pullout section would become distorted or bent in any way that section would be effectively stuck in place, requiring the overwidth restrictions to remain intact for any subsequent trips until the pullout section could be repaired or replaced, coupled with insufficient strength to accommodate heavy loads. Additionally, these adapters only adapted the width, but not the height.

One other prior hauling adapter included a rotatable section attached to the edge of a trailer whereby, when engaged in a “useable” position, extended the effective width of a trailer to accommodate slightly wider loads. These adapters suffered from the same shortcomings as the pullout sections, in that they were not of sufficient strength to support the loads that are often requisite for oversize loads and were subject to bending further weakening the functionality of the adapter. These adapters also lacked the adjustable height feature.

Another hauling adapter focused on increasing the width of the trailer, but also made adjustments for allowing these side sections to be mounted lower than the platform of the original trailer thereby allowing for transport of high clearance loads, originally needing to adhere to high clearance requirements, to travel on modern highways. This adapter had the shortcomings of being securely attached to the trailering device, and therefore was particularly difficult to retract and/or remove when it was not needed. Furthermore, this adapter requires a significant amount of time to engage or disengage upon decision that the additional width and/or height requirements may or may not be needed on a certain portion of a trip.

Because of the restrictions placed upon trailering large loads (i.e. overwidth and/or high clearance loads), it is desirable to have devices which allow for the trailering of overwidth and/or high clearance loads on one portion of a trip, while allowing for fast and easy disassembly of the device, reducing it to standard trailer width and height requirements for a subsequent portion of a trip. This reduction in size when larger dimensions of the trailer are not needed allows for drivers to follow the requirements set forth for non-high clearance, non-overwidth loads, thus reducing the heightened standards imposed upon drivers carrying loads considered either overwidth or high clearance by Department of Transportation standards.

Prior art has shown that trailer adaptation devices are a viable way to allow for an overwidth or high clearance specified load to be transported on one portion of a trip, while requiring adherence only to standard trailering regulations due to retraction of the adaptation device for a subsequent part of a trip. The problems inherent with the prior art include the overly burdensome tasks of both retracting the adaptation device on portions of the trip when it is not required as well as removing the apparatus when trailering loads on trips that do not require an overwidth or high clearance designation. The present invention solves these problems by introducing a welded and pinned steel structure, which is easily engaged or disengaged via an actuator during portions of a trip where different trailering requirements may or may not be needed, along with providing a trailer adaptation system that can be easily removed and re-mounted on any other preferred flatbed trailer that might be available.

In these respects, the retractable transportation system according to the present invention substantially departs from the conventional concepts and designs of the prior art, and in so doing provides an apparatus primarily developed for the purpose of providing a removable retractable way to transport overwidth and/or high clearance loads on a conventional flatbed trailer.

### BRIEF SUMMARY OF THE INVENTION

In view of the foregoing disadvantages inherent in the known types of trailering adapters now present in the prior art, the present invention provides a new retractable transportation system construction wherein the same can be utilized for providing a removable retractable way to transport overwidth and/or high clearance loads on a flatbed trailer or vehicle used for hauling said loads.

The general purpose of the present invention, which will be described subsequently in greater detail, is to provide a new retractable transportation system that has many of the advantages of the trailering adapters mentioned heretofore and many novel features that result in a new retractable transportation system which is not anticipated, rendered obvious, suggested, or even implied by any of the prior art trailering adapters, either alone or in any combination thereof.

To attain this, the present invention generally comprises a plurality of support members attachable to a trailer bed, a plurality of first arms and second arms pivotally attached to opposing ends of the support members, a first platform attached to the first arms, a second platform attached to the second arms, and a plurality of actuators connected to the support member and the arms for elevating/lowering the platforms.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a retractable transportation system that will overcome the shortcomings of the prior art devices.

A second object is to provide a retractable transportation system for transporting loads on a vehicle or trailer with a flatbed design that would otherwise be too wide or too tall to fit on the vehicle or trailer due to Department of Transportation regulations and vehicle and trailer size constraints.

Another object is to provide a retractable transportation system that is easily retracted, via an actuator, when not transporting an overwidth or high clearance load, so that the driver may adhere to lessened standards imposed upon standard width and height loads.

An additional object is to provide a retractable transportation system that may be transplanted from one vehicle to another as needed.

A further object is to provide a retractable transportation system that will be able to withstand the weight of these overwidth and high clearance loads, commonly associated with, but not limited to transporting tractors and combines that are generally considered overwidth or high clearance.

Another object is to provide a retractable transportation system that can be attached to an existing trailer or vehicle along with being easily removed.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention.

FIG. 2 is an upper perspective view of the present invention positioned upon a trailer bed.

FIG. 3 is a rear end view of the present invention with the platforms folded down.

FIG. 4 is a rear end view of the present invention with the platforms partially folded up.

FIG. 5 is a rear end view of the present invention with the platforms folded up in a compact storage position.

FIG. 6 is an upper perspective view of the present invention positioned upon a shorter trailer bed.

FIG. 7 is an upper perspective view of an alternative embodiment.

FIG. 8 is a magnified upper perspective view of the connecting structure for the actuator and the arms.

### DETAILED DESCRIPTION OF THE INVENTION

A. Overview

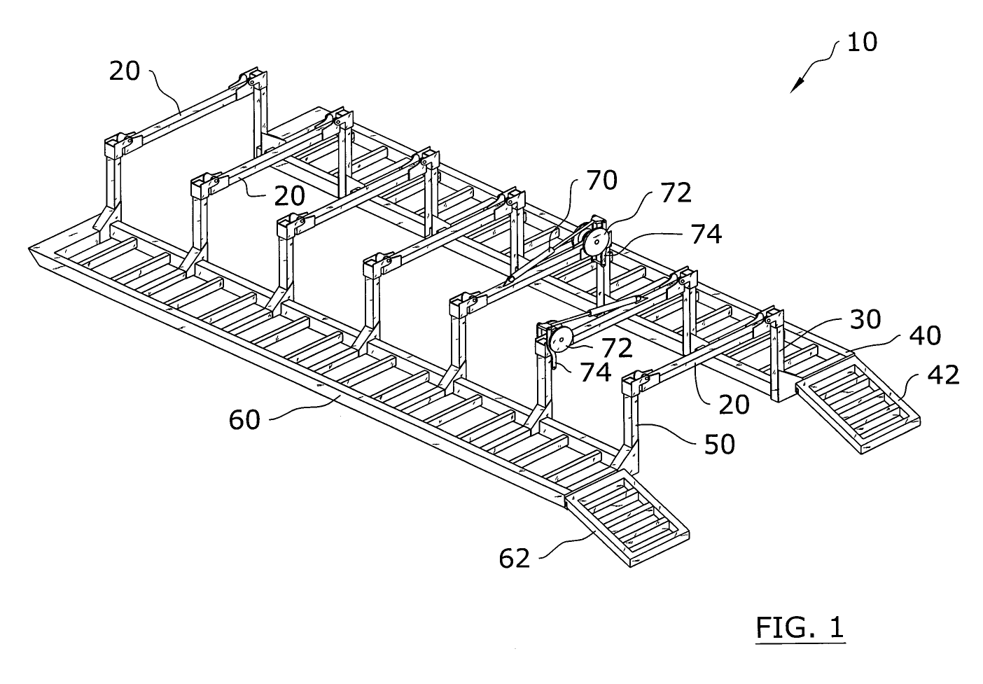

Turning now descriptively to the drawings, in which similar reference characters denote similar elements throughout the several views, FIGS. 1 through 8 illustrate a retractable transportation system 10, which comprises a plurality of support members 20 attachable to a trailer bed 14, a plurality of first arms 30 and second arms 50 pivotally attached to opposing ends of the support members 20, a first platform 40 attached to the first arms 30, a second platform 60 attached to the second arms 50, and a plurality of actuators 70 connected to the support member 20 and the arms for elevating/lowering the platforms.

B. Support Members

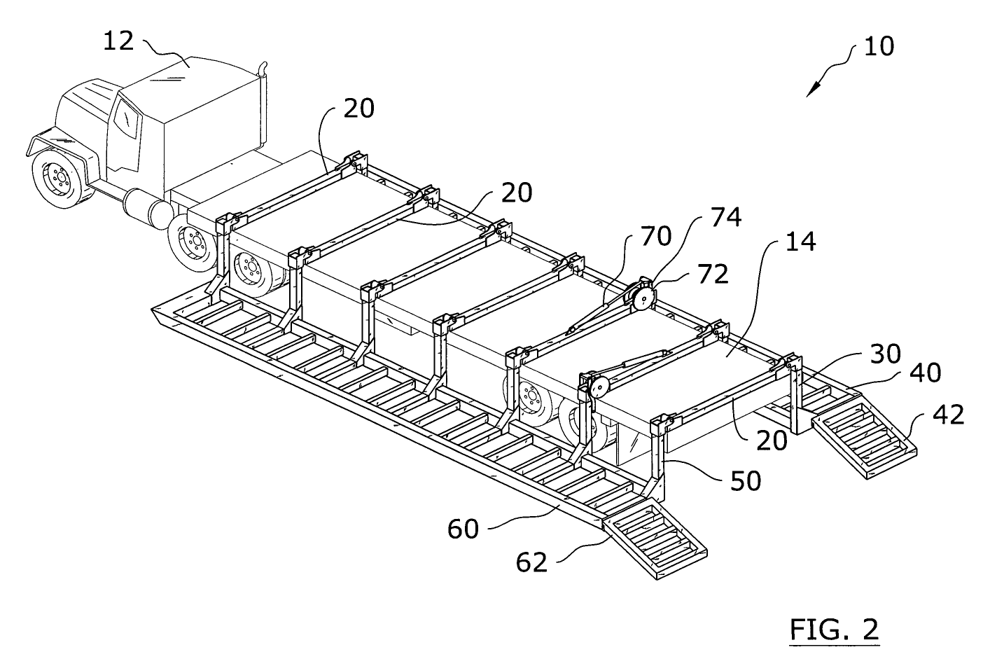

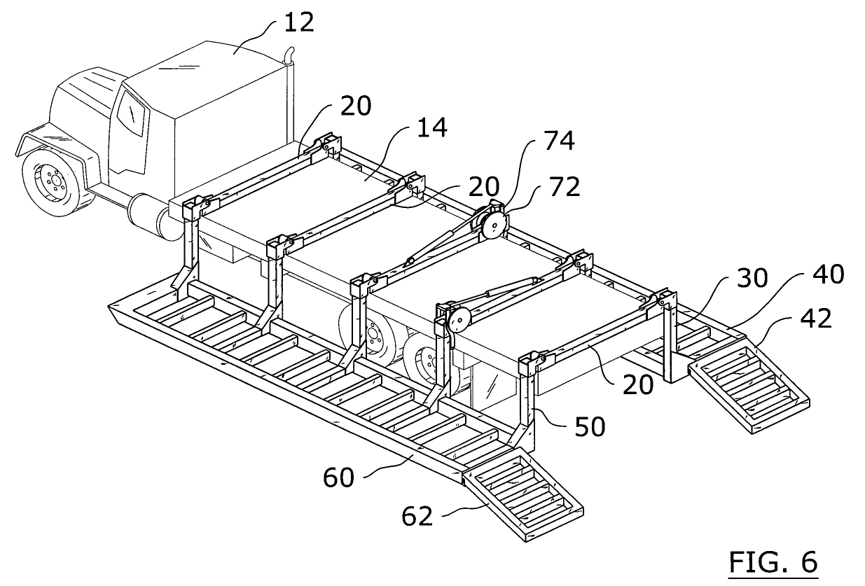

FIGS. 1, 2, 6 and 7 illustrate a plurality of support members 20 attachable to a trailer bed 14 (of a trailer or a truck 12) by conventional fasteners. The support members 20 are preferably substantially parallel to one another as best illustrated in FIGS. 1 and 2 of the drawings. The support members 20 are preferably each comprised of a length to extend across the entire width of the trailer bed 14 as illustrated in FIGS. 2 and 6 of the drawings. The support members 20 may be comprised of various cross sectional shapes and may be a tubular structure or solid structure.

C. Arms

A plurality of first arms 30 are pivotally attached to a first end of the support members 20 as shown in FIGS. 1, 2, 6 and 7 of the drawings. As further shown in the drawings, a plurality of second arms 50 are pivotally attached to a second end of the support members 20 opposite of the first arms 30.

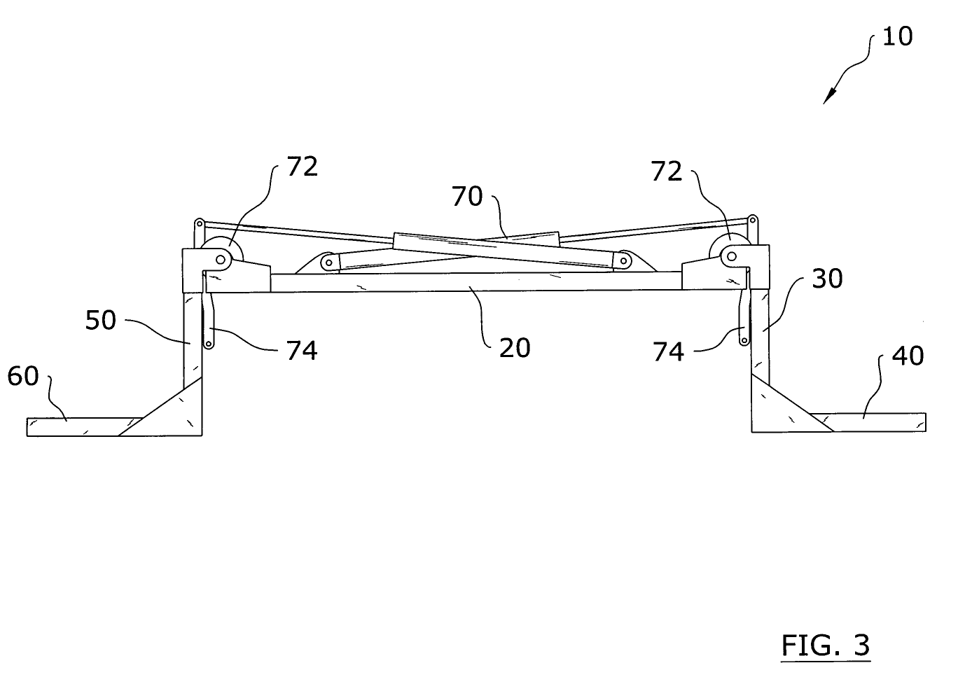

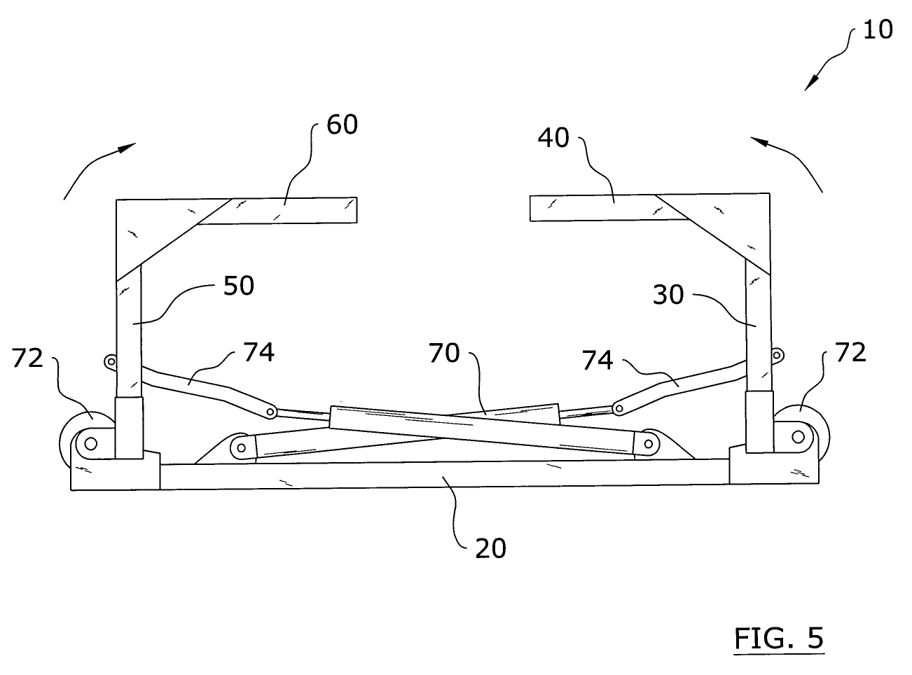

The first arms 30 and the second arms 50 form an inverted U-shaped structure with the support members 20 when in a lowered position as shown in FIG. 3 of the drawings. The first arms 30 and the second arms 50 form an upright U-shaped structure with the support members 20 when in a raised position as shown in FIG. 5 of the drawings.

The first arms 30 and the second arms 50 each have a rotational axis transverse with respect to the support members 20. The arms 30, 50 are attached to the opposing ends of corresponding support members 20 as shown in the drawings.

D. Platforms

A first platform 40 comprised of an elongated structure is preferably orthogonally attached to the first arms 30 as shown in FIGS. 1 through 7 of the drawings. A first ramp 42 is also preferably pivotally attached to the first platform 40 as shown in FIGS. 1 and 2.

A second platform 60 comprised of an elongated structure is preferably orthogonally attached to the second arms 50 as shown in FIGS. 1 through 7 of the drawings. A second ramp 62 is pivotally attached to the second platform 60 as further shown in the drawings.

The first platform 40 and the second platform 60 are preferably substantially parallel to a longitudinal axis of the trailer bed 14 as illustrated in FIGS. 2 and 6 of the drawings. The first platform 40 and the second platform 60 are also preferably positioned below the upper surface of the trailer bed 14 when the arms 30, 50 are in the lowered position as shown in FIGS. 2 and 6 of the drawings. The distance below the upper surface of the trailer bed 14 is determined in part by the length of the arms 30, 50. It can be appreciated that this distance may be increased or decreased by the usage of adjustable arms 30, 50.

The first platform 40 and the second platform 60 may be comprised of various structures capable of supporting a heavy vehicle (e.g. tractor). The platforms 40, 60 may be comprised of a grid structure as shown in FIGS. 1, 2, 6 and 7 of the drawings. However, various other structures may be utilized to construct the platform s 40, 60. The ramps 42, 62 allow for a user to drive a vehicle directly upon the platforms 40, 60.

E. Actuators and Connecting Structure

At least one actuator is mechanically connected to the support members 20, the first arms 30 and the second arms 50 for elevating and lowering the first platform 40 and the second platform 60 as shown in FIGS. 1 through 7 of the drawings. The actuators 70 are mechanically connected to the first arms 30 and the second arms 50 by a connecting structure that allows for the pivoting of the first arms 30 and the second arms 50 approximately one-hundred-eighty degrees as shown in FIGS. 3 through 5 of the drawings.

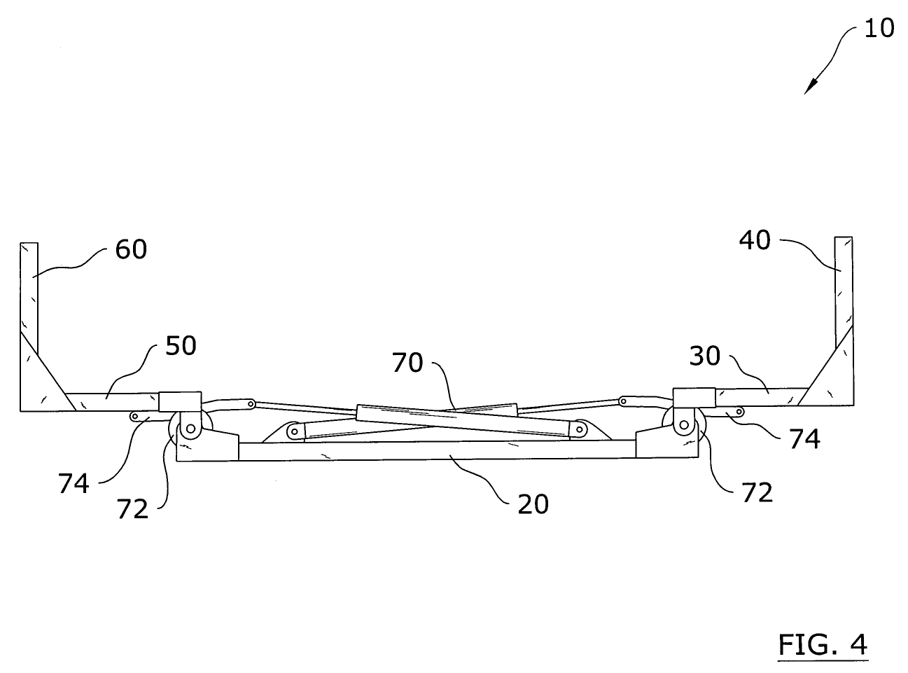

The connecting structure is preferably comprised of a first fulcrum 72, a first connector member 74, a second fulcrum 72 and a second connector member 74. The first fulcrum 72 is attached to the first end of one of the support members 20 and the first connector member 74 is attached to a first actuator. The first connector member 74 is movably positioned adjacent to one of the first arms 30 as shown in FIGS. 1 through 7 of the drawings. The first connector member 74 pivots upon the first fulcrum 72 as illustrated by FIGS. 3 and 4 of the drawings.

The second fulcrum 72 is attached to the second end of one of the support members 20 and the second connector member 74 is attached to a second actuator. The second connector member 74 is movably positioned adjacent to one of the second arms 50 as shown in FIGS. 1 through 7 of the drawings. The second connector member 74 pivots upon the second fulcrum 72 as illustrated by FIGS. 3 and 4 of the drawings.

The fulcrums 72 each preferably have a curved upper portion. The fulcrums 72 may also have a flanged circular structure that is rotatably attached to the support members 20 which allows for the free movement of the connector member 74 upon the same.

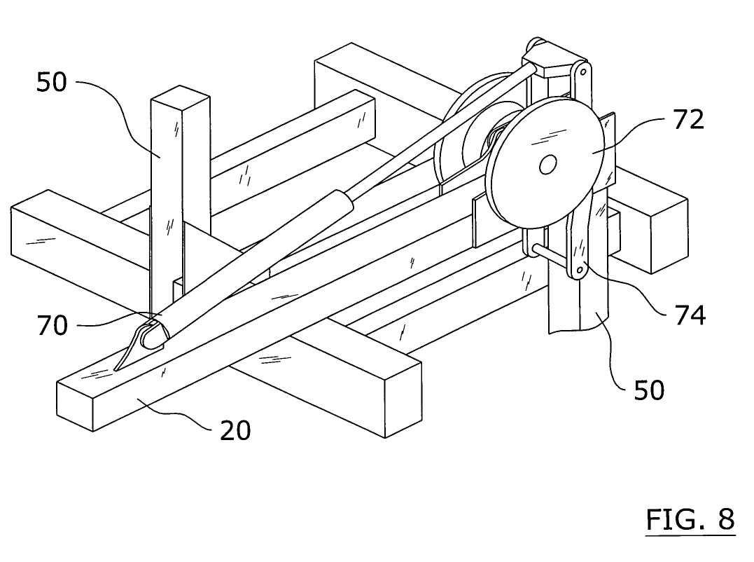

The first connector member 74 and the second connector member 74 are each preferably comprised of a looped structure as illustrated in FIG. 8 of the drawings. The connector members 74 are adjacent to an inner portion of the arms when the arms are in a lowered state and the connector members 74 are adjacent to an outer portion of the arms when the arms are in a raised state as shown in FIGS. 3 and 5 respectively. The outer looped end of the connector member 74 pushes arms 30, 50 upwardly when the arms 30, 50 are below the upper surface of the trailer. The outer looped end of the connector member 74 draws the arms 30, 50 inwardly after arms 30, 50 have moved above the upper surface of the trailer bed 14 as shown in FIG. 5 of the drawings.

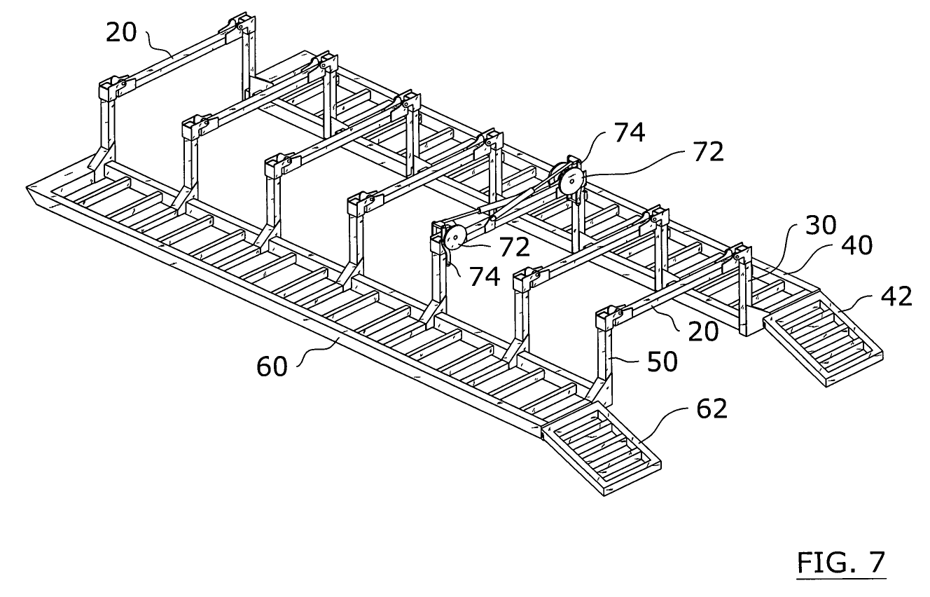

The actuators 70 are comprised of at least one first actuator mechanically connected to at least one of the first arms 30 and at least one second actuator mechanically connected to at least one the second arms 50 as shown in the figures. The at least one first actuator and the at least one second actuator may be positioned upon a single support member 20 of the support members 20 as shown in FIG. 7 of the drawings.

The actuators 70 may be comprised of various devices such as electrical-mechanical, hydraulic and the like. It can also be appreciated that a single actuator may be utilized to lift and lower all of the arms 30, 50.

F. Control Unit

A control unit is preferably in communication with the actuators 70 for controlling the operation of the actuators 70. The control unit may be comprised of various structures (e.g. computer, electronic device, hydraulic valve unit, etc.). The control unit is preferably controllable by an operator for selectively raising and lowering the arms 30, 50.

G. Operation of Invention

To load a vehicle (or other device), the user manipulates the control unit so as to lower the arms 30, 50 which causes the platforms 40, 60 to be positioned in a lowered and outward position with respect to the trailer bed 14 as shown in FIGS. 2, 3 and 6 of the drawings. The user then folds the ramps 42, 62 down and then loads the vehicle onto the platforms 40, 60. A truck 12 is then able to transport the loaded vehicle to a desired location where the vehicle may be unloaded. The lowered position of the platforms 40, 60 allows for the loading of vehicles of increased height. The extended position of the platforms 40, 60 allows for the loading of vehicles of increased width.

After the vehicle is unloaded from the platforms 40, 60, the user then manipulates the control unit to cause the arms 30, 50 to pivot upwardly as shown in FIGS. 4 and 5 of the drawings. Once the arms 30, 50 are in the upright position, the operator is then able to operate the truck 12 as a normal width vehicle upon a roadway without restrictions.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

I claim:

1. A retractable transportation system, comprising:
a plurality of support members attachable to a trailer bed;
a plurality of first arms pivotally attached to a first end of said support members;
a plurality of second arms pivotally attached to a second end of said support members opposite of said first arms;
a first platform attached to said first arms;
a second platform attached to said second arms; and
at least one actuator mechanically connected to said support members, said first arms and said second arms for elevating and lowering said first platform and said second platform.

2. The retractable transportation system of claim 1, including a control unit in communication with said at least one actuator for controlling the operation of said at least one actuator.

3. The retractable transportation system of claim 1, wherein said first platform and said second platform are each comprised of an elongated structure.

4. The retractable transportation system of claim 1, wherein said first platform is attached substantially orthogonal to said first arms and wherein said second platform is attached substantially orthogonal to said second arms.

5. The retractable transportation system of claim 1, wherein said first arms and said second arms form an inverted U-shaped structure with said support members when in a lowered position.

6. The retractable transportation system of claim 5, wherein said first arms and said second arms form a U-shaped structure with said support members when in a raised position.

7. The retractable transportation system of claim 1, wherein said first arms and said second arms have a rotational axis transverse with respect to said support members.

8. The retractable transportation system of claim 1, wherein said support members are substantially parallel to one another.

9. The retractable transportation system of claim 1, wherein said support members are equidistantly spaced apart from one another.

10. The retractable transportation system of claim 1, wherein said at least one actuator is comprised of at least one first actuator mechanically connected to at least one of said first arms and at least one second actuator mechanically connected to at least one said second arms.

11. The retractable transportation system of claim 10, wherein said at least one first actuator and said at least one second actuator are positioned upon a single support member of said support members.

12. The retractable transportation system of claim 1, including a first ramp attached to said first platform and a second ramp attached to said second platform.

13. The retractable transportation system of claim 12, wherein said first ramp is pivotally attached to said first platform and wherein said second ramp is pivotally attached to said second platform.

14. The retractable transportation system of claim 1, wherein said at least one actuator is mechanically connected to said first arms and said second arms by a connecting structure that allows for the pivoting of the first arms and said second arms approximately one-hundred-eighty degrees.

15. The retractable transportation system of claim 14, wherein said connecting structure is comprised of:
a first fulcrum attached to said first end of one of said support members;
a first connector member attached to a first actuator of said at least one actuator and movably positioned adjacent to one of said first arms, wherein said first connector member pivots upon said first fulcrum;
a second fulcrum attached to said second end of one of said support members; and
a second connector member attached to a second actuator of said at least one actuator and movably positioned adjacent to one of said second arms, wherein said second connector member pivots upon said second fulcrum.

16. The retractable transportation system of claim 15, wherein said first fulcrum and said second fulcrum each have a curved upper portion.

17. The retractable transportation system of claim 15, wherein said first connector member and said second connector member are each comprised of a looped structure.

18. The retractable transportation system of claim 17, wherein said connector members are adjacent to an inner portion of said arms when said arms are in a lowered state and wherein said connector members are adjacent to an outer portion of said arms when said arms are in a raised state.

19. A retractable transportation system, comprising:
a plurality of support members attachable to a trailer bed, wherein said support members are substantially parallel to one another;
a plurality of first arms pivotally attached to a first end of said support members;
a plurality of second arms pivotally attached to a second end of said support members opposite of said first arms, wherein said first arms and said second arms form an inverted U-shaped structure with said support members when in a lowered position, and wherein said first arms and said second arms form a U-shaped structure with said support members when in a raised position;
wherein said first arms and said second arms have a rotational axis transverse with respect to said support members;
a first platform comprised of an elongated structure orthogonally attached to said first arms;
a first ramp pivotally attached to said first platform;
a second platform comprised of an elongated structure orthogonally attached to said second arms;
a second ramp pivotally attached to said second platform;
at least one actuator mechanically connected to said support members, said first arms and said second arms for elevating and lowering said first platform and said second platform; and
a control unit in communication with said at least one actuator for controlling the operation of said at least one actuator;
wherein said at least one actuator is mechanically connected to said first arms and said second arms by a connecting structure that allows for the pivoting of the first arms and said second arms approximately one-hundred-eighty degrees, wherein said connecting structure is comprised of:
a first fulcrum attached to said first end of one of said support members;
a first connector member attached to a first actuator of said at least one actuator and movably positioned adjacent to one of said first arms, wherein said first connector member pivots upon said first fulcrum;
a second fulcrum attached to said second end of one of said support members; and
a second connector member attached to a second actuator of said at least one actuator and movably positioned adjacent to one of said second arms, wherein said second connector member pivots upon said second fulcrum;
wherein said first fulcrum and said second fulcrum each have a curved upper portion;
wherein said first connector member and said second connector member are each comprised of a looped structure;
wherein said connector members are adjacent to an inner portion of said arms when said arms are in a lowered state and wherein said connector members are adjacent to an outer portion of said arms when said arms are in a raised state.

20. The retractable transportation system of claim 19, wherein said at least one actuator is comprised of at least one first actuator mechanically connected to at least one of said first arms and at least one second actuator mechanically connected to at least one said second arms, wherein said at least one first actuator and said at least one second actuator are positioned upon a single support member of said support members.
